(19) United States
(12) Patent Application Publication
(10) Pub. No.: US 2021/0355612 A1
(43) Pub. Date: Nov. 18, 2021

(54) FABRIC, IN PARTICULAR FOR USE AS A PRIVACY OR ANTI-GLARE PROTECTION, AND METHOD FOR PRODUCING A FABRIC ACCORDING TO THE INVENTION

(71) Applicant: NEUTEX HOME DECO GMBH, Münchberg (DE)

(72) Inventor: Stefan Bauer, Münchberg (DE)

(21) Appl. No.: 17/284,940

(22) PCT Filed: Feb. 18, 2019
(86) PCT No.: PCT/EP2019/053909

§ 371 Date: Apr. 13, 2021

(30) Foreign Application Priority Data
Nov. 5, 2018 (DE) 10 2018 127 460.2
Dec. 6, 2018 (DE) 10 2018 131 135.4

(51) Int. Cl. D03D 19/00

(52) U.S. Cl. CPC D03D 19/00; D10B 2401/20; D10B 2503/03

(57) ABSTRACT

The invention relates to a fabric (10), in particular for use as a privacy and/or anti-glare protection, which is based on a lattice fabric framework produced by means of a leno loom, wherein the fabric (10) has, preferably alternately, shading sections (20) and translucent sections (30), wherein the fabric (10) has, in at least one translucent section (30) first weft threads (31) which are associated with the translucent section (30) and are arranged parallel to one another at a lattice spacing, and a number of standing threads (34) extending at right angles to the first weft threads (31), and a number of leno threads (39), which interlink the first weft threads (31) and the standing threads (35) in the manner of a leno fabric, wherein the fabric (10) has, in at least one shading section (20), a number of standing threads (35) and a number of leno threads (39), wherein the leno threads (39) in the shading section (20) run substantially parallel to the standing threads (35) and are predominantly not interlinked with the standing threads (35), and second weft threads (22), which are associated with the shading section (20) and consist of a different material from the first weft threads (31).

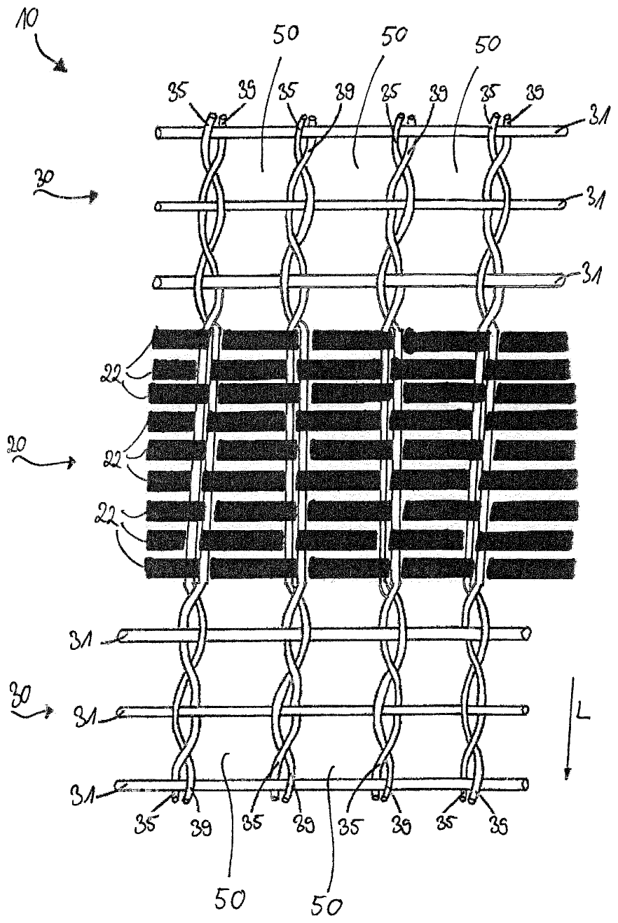

The invention relates to a fabric, in particular for use as a privacy and/or anti-glare protection, which is based on a lattice fabric framework produced by means of a leno loom, wherein the fabric has, preferably alternately, shading sections and translucent sections according to the feature combination of claim 1. Furthermore, the invention relates to a method for producing a fabric according to the invention.

Textile structures, in particular fabrics are known from the state of the art, which are used in conjunction with inside blinds or darkening curtains. In this case, extremely complicated constructions possibly exist.

In the document DE 10 2014 106 602 A1, for example, an arrangement for generating a light effect is disclosed. This arrangement comprises a plurality of sections that are superimposed and arranged on top of one another. Moreover, an effect area structure as well as a divergence area structure are provided.

Starting from the known state of the art, it is a task of the present invention to further develop a fabric which may in particular serve as a privacy and/or anti-glare protection, wherein the fabric is intended to produce an effect in shading sections to be formed such that these shading sections quasi should stand freely in the air. This enables a clear sight toward the outside to be allowed between the shading sections.

Furthermore, it is a task of the present invention to propose a method by means of which such a fabric according to the invention is producible.

According to the invention, this task is solved with respect to the fabric, in particular to the fabric for use as a privacy and/or anti-glare protection, by the subject matter of claim 1. With respect to the method for producing a fabric according to the invention, the task is solved by the features of claim 10.

The invention is based on the idea that the fabric is based on a lattice fabric framework produced by means of a leno loom, wherein the fabric includes, preferably alternately, shading sections and translucent section. In other words, the lattice fabric framework may be formed such that shading sections and translucent sections are always formed in an alternating manner.

In this case, it is possible for the shading sections and the translucent sections to mutually alternate in a longitudinal extension. In a further embodiment of the invention, it is possible for the shading sections to be formed mutually alternating in a transverse extension of the fabric.

Furthermore, it is possible for the shading sections to be formed in certain geometric shapes. Here, circular shapes and/or rectangle shapes and/or spiral shapes and/or triangle shapes and/or polygon shapes etc. are possible, for example. It is moreover possible for the shading sections to include figurative representations.

In a further embodiment of the invention, it is possible for the fabric to preponderantly consist of shading sections, wherein a translucent section is formed in at least one shading section. In other words, it is possible for a translucent section to be completely surrounded or delimited by a shading section. Moreover, it is possible for a shading section to be completely surrounded by a translucent section.

The fabric according to the invention is intended to serve in particular as a privacy and/or anti-glare protection. As a privacy and/or anti-glare protection, an interior curtain, a panel, a double blind or a blind is in particular to be understood which can be or is arranged in front of a window, a glass door or similar.

In a particularly preferred use of the fabric as a double blind, two fabric layers or two fabric sections may thus be arranged with respect to one another such that, in a top view of the fabric, the translucent sections are covered by shading sections arranged in front of them.

If desired, the translucent sections may be covered by shading sections so that a complete shading and/or a complete privacy and/or anti-glare protection is enabled.

It is furthermore possible for the translucent sections to be only partially covered by the shading sections so that a regulated shading may be performed.

A shading section may also be referred to as a dense section or opaque section. It should be pointed out that the described shading sections in the present invention are not necessarily defined according to DIN EN 14500/14501.

A translucent section may also be referred to as a transparent section.

In at least one translucent section, the fabric has:
first weft threads which are associated with the translucent section and are arranged parallel to one another at a lattice spacing, and
a number of standing threads extending at right angles to the first weft threads, and
a number of leno threads, which interlink the first weft threads and the standing threads in the manner of a leno fabric.

The lattice fabric framework hereinafter is defined as the fabric framework that is formed or further developed differently in at least one shading section and at least one translucent section.

As a parallel arrangement of threads to one another, a mathematical parallel arrangement is not to be understood hereinafter. Rather, the general orientation of the threads to one another, which is typical for fabrics, is to be understood. It is quite possible for the threads to contact one another in at least slight sections.

As standing threads extending at right angles to the first weft threads, standing threads arranged in particular transversely to the weft threads are to be understood. In the arrangement at right angles, a mathematical rectangular arrangement should not be insisted on. It rather indicates the rough orientation of the threads to one another.

In particular, the leno threads and the standing threads are arranged mutually alternating in a perpendicular direction to the weft threads. In other words, a leno thread and a standing thread form a warp thread pair.

At least one translucent section consequently is substantially formed as a lattice fabric, so that in each case between two weft threads arranged in parallel to one another and in each case between two warp thread pairs, at least one lattice opening is formed. Due to the lattice opening, the translucent section has a translucent effect. The distance of the warp thread pairs from one another as well as the distance of the weft threads from one another define the size of the lattice openings.

In the shading section, the fabric has the number of standing threads and the number of leno threads, wherein the leno threads in the shading section substantially extend in parallel to the standing threads and predominantly do not form loops with the standing threads. In one embodiment of the invention, the leno threads in the shading section do not form loops with the standing threads. Partial loops in the shading section are merely required to be able to form structures and/or patterned breakthroughs. In other words, the fabric has in the shading section the same number of leno threads and the same number of standing threads as in an adjacent translucent section that is formed according to the invention.

The leno threads, however, are not used as in the translucent section. In the shading section, the leno threads do not form necessarily or preponderantly loops, in particular no loops, with the standing threads. In this context as well, the mutual parallel arrangement of the leno threads and the standing threads is not to be understood strictly mathematically, but is rather to be understood as a rough orientation of the standing threads and the leno threads or the previously formed warp thread pairs of a translucent section formed according to the invention.

Moreover, second weft threads, which are associated with the shading section are formed in the shading section which consist and/or are made of a material which differs from that of the first weft threads. By way of example, the second weft threads are woven mutually alternating by the leno threads and the standing threads. In case of subsequent second weft threads, this is performed mutually alternating.

The second weft threads, which may also be referred to as weft threads of a second kind, consist of another material than the first weft threads, which in turn may be referred to as weft threads of a first kind. By means of the second weft threads, in particular by means of a corresponding material selection in connection with the second weft threads, the shading section may be formed by a fabric section that is more or less opaque.

The first weft threads associated with the translucent section may consist of different materials in at least one translucent section. It is thus possible for different first weft threads to be formed in a translucent section.

The second weft threads associated with the shading section may consist of different materials in at least one shading section. It is thus possible for different second weft threads to be formed in a shading section.

The designation “first” weft thread and “second” weft thread merely clarifies whether this weft thread is a weft thread of the translucent section or a weft thread of the shading section.

A first weft thread may also be referred to as a translucent section weft thread. A second weft thread may also be referred to as a shading portion weft thread.

The entirety of the weft threads of the translucent section does not need to have the same material, it is rather possible for a plurality of weft threads of the translucent section to be made of different materials.

The entirety of the weft threads of the shading section does not need to have the same material, it is rather possible for a plurality of weft threads of the shading section to be made of different materials.

Preferably, the distance between the second weft threads is less than the distance between the first weft threads.

The distances between the second weft threads preferably are many times smaller than the distances between the first weft threads. In a particularly preferred embodiment of the invention, the second weft threads adjoin each other so that no or only a very small light content may shine through between the second weft threads.

In a further embodiment of the invention, it is possible for the leno threads and/or the standing threads to be filaments, in particular monofilaments. It is possible for the leno threads and the standing threads to be formed similarly or differently.

The leno threads and/or the standing threads preferably are formed to be transparent, in particular transparent in a crystal-clear way. In a further embodiment of the invention, it is possible for leno threads and/or the standing threads to be formed in a darkly transparent way. This is in particular performed by dying a filament, in particular a monofilament.

In again a further embodiment of the invention, it is possible for the first weft threads to be made of a transparent, in particular crystal-clear material, or a material colored to be darkly transparent. The appropriate material selection in connection with the first weft threads allows a particularly well diaphanous translucent section to be formed. In other words, it is possible that due to the correct material selection in connection with the first weft threads such a translucent section can be made available through which particularly much light is able to be incident into a room from the outside.

In a further embodiment of the invention, it is possible for the second weft threads to be made of a textile material and/or of natural materials. As a natural material, bast materials, natural fiber materials, bamboo materials, straw materials etc. are possible, for example. This enables the fabric to be selectively formed corresponding to the interior design of a buyer. Apart from the fabric's functionality, this may play an important role as an aesthetic aspect.

In a particularly preferred embodiment of the invention, the second weft threads are made of a substantially opaque material. Consequently, the shading section may be formed to be particularly opaque.

Preferably, the fabric has a plurality of shading sections and a plurality of translucent sections formed between the shading sections.

In a particularly preferred embodiment of the invention, all of the shading sections and all of the translucent sections are formed as described above.

In the longitudinal extension of the fabric, the shading sections preferably each have a larger extension than the translucent sections. When the fabric according to the invention is used as a fabric for a double blind, a translucent section allows to be thus completely covered by a shading section positioned in front of the translucent section in the viewing direction.

According to a further aspect, the present invention is based on a method for producing a fabric according to the invention, wherein, according to the invention, a leno loom is used for producing the fabric according to the invention. The production of the fabric according to the invention is in particular performed on a dobby weaving machine or a Jacquard weaving machine.

In a first possible embodiment of the method according to the invention, the leno threads and/or standing threads are filaments having a low-melting component. In a first step, the weaving process is performed in a leno loom in this embodiment. In a second step, namely an equipment process, a melting operation is triggered for fixing the filament crossing points. The fabric is thus stiffened. The second step is preferably performed in a clamping frame. In the clamping frame, a melting and fixing operation can be triggered.

In a second possible embodiment of the method according to the invention, the leno threads and/or standing threads are filaments not having a low-melting component. In a first step, the weaving operation is performed in a leno loom in this embodiment. In a second step, namely an equipment process, a wet-chemical finishing is performed. The fabric is thus stiffened. The second step is preferably performed in a Foulard. A chemical stiffening is performed in the Foulard. Preferably, a chemical stiffening here is performed by means of acryl and/or acetate and/or polyurethane and/or a stiffening resin. In a third step, a drying and fixation process of the chemically stiffened fabric is performed.

The invention will be explained in more detail below using an exemplary embodiment with reference to the attached FIGURE.

The FIGURE shows in this case a fabric 10, which is in particular used as a fabric for a double blind. In this case, the fabric 10 comprises a plurality of sections, wherein in the FIGURE, one shading section 20 and two translucent sections 30 are formed. Actually, a fabric has both a plurality of shading sections and a plurality of translucent sections formed in between them.

In the translucent section 30, the fabric has first weft threads 31 arranged substantially in parallel to one another at a desired lattice distance. Furthermore, standing threads 35 and leno threads 39 can be recognized. One standing thread 35 and one leno thread 29 form a warp thread pair 40 in each case.

In the represented example, both the standing threads 35 and the leno threads 39 are made of a crystal-clear transparent monofilament. In the translucent section 30, the leno threads 39 are arranged such that they intertwine the first weft threads 31 and the standing threads 35 in the manner of a leno fabric. The crystal-clear transparent monofilament may be, for example, 56 dtex PES. The use of this material is also possible in other embodiments that are independent of the represented FIGURE.

The translucent sections 30 have corresponding lattice openings 50. Together with the material of the standing threads 35 and the leno threads 39, the lattice openings 50 contribute to the translucent effect.

In a particularly preferred embodiment of the invention, the first weft threads 31 are formed of a meting filament yarn, in particular a PES melting filament yarn having 50 dtex, for example. The use of this material is also possible in other embodiments that are independent of the represented FIGURE.

In the shading section 20, the leno threads 39 are no longer arranged to be contorted but run substantially in parallel to the standing threads 35. No loops and no (large) lattice openings are formed.

Between the standing and leno threads running in parallel, second weft threads 22 are woven in. It can be recognized that the second weft threads 22 are made of a material which differs from that of the first weft threads 31. Furthermore, the material thickness of the second weft threads 22 is many times larger than the material thickness of the first weft threads 31.

In the interwoven state, the second weft threads 22 adjoin each other. For reasons of representation, this cannot be illustrated exactly in the FIGURE. However, it is clear that the shading section 20 is formed to be by far more opaque and less translucent than the translucent sections 30.

Furthermore, it can be recognized that the shading section 20 has a larger extension in the longitudinal direction L of the fabric 10 than the translucent sections 30. When the fabric 10 is used as a double blind fabric, this allows a shading section 20 to be positioned or arranged in front of a translucent section 30 so that the translucent section 30 can be completely covered by a shading section 20.

A translucent section 30 following the shading section 20 further below, in turn has the standing threads 35 and the leno threads 39 which extend, starting from the translucent section 30 formed above, across the shading section 20 up to the next translucent section 30.

The represented fabric 10 is produced according to the invention on a leno loom.

### REFERENCE NUMERALS

10 fabric
20 shading section
22 second weft thread
30 translucent section
31 first weft thread
35 standing thread
39 leno thread
40 warp thread pair
50 lattice opening
L longitudinal direction

1. A fabric (10), in particular for use as a privacy and/or anti-glare protection, which is based on a lattice fabric framework produced by means of a leno loom, wherein the fabric (10) has, preferably alternately, shading sections (20) and translucent sections (30),
wherein the fabric (10) has, in at least one translucent section (10)
first weft threads (31) which are associated with the translucent section (30) and are arranged parallel to one another at a lattice spacing, and
a number of standing threads (35) extending at right angles to the first weft threads (31), and
a number of leno threads (39), which interlink the first weft threads (31) and the standing threads (35) in the manner of a leno fabric,
wherein the fabric (10) has, in at least one shading section (20),
the number of standing threads (35) and the number of leno threads (39), wherein the leno threads (39) in the shading section (20) run substantially parallel to the standing threads (35) and are predominantly not interlinked with the standing threads (35), and
second weft threads (22), which are associated with the shading section (20) and consist of a material different from that of the first weft threads (31).

2. The fabric (10) according to claim 1,
characterized in that
the leno threads (39) and/or the standing threads (35) are filaments, in particular monofilaments.

3. The fabric (10) according to claim 1,
characterized in that
the leno threads (39) and/or the standing threads (35) are transparent, in particular crystal-clear or darkly transparent.

4. The fabric (10) according to claim 1,
characterized in that
the first weft threads (31) are made of a transparent, in particular crystal-clear material, or a material colored to be darkly transparent.

5. The fabric (10) according to claim 1,
characterized in that
the second weft threads (22) are made of a textile material and/or of natural materials.

6. The fabric (10) according to claim 1,
characterized in that
the second weft threads (22) are made of a substantially opaque material.

7. The fabric (10) according to claim 1,
characterized in that
the first weft threads (31) which are associated with the translucent section consist of different materials in at least one translucent section (30).

8. The fabric (10) according to claim 1,
characterized in that
the second weft threads (22) which are associated with the shading section consist of different materials in at least one shading section (20).

9. The fabric (10) according to claim 1,
characterized in that,
in the longitudinal extension of the fabric, the shading sections (20) each have a larger extension than the translucent sections (30).

10. A method for producing a fabric (10) according to the invention according to claim 1,
characterized in that
the production of the fabric (10) is performed on a leno loom, in particular in a Jacquard weaving machine or a dobby weaving machine.
